(19) United States
(12) Patent Application Publication
(10) Pub. No.: US 2003/0112577 A1
(43) Pub. Date: Jun. 19, 2003

(54) Niobium particle, niobium sintered body, niobium formed body and niobium capacitor

(75) Inventors: Isao Kabe, Chiba (JP); Kazumi Naito, Chiba (JP)

Correspondence Address: SUGHRUE MION, PLLC, 2100 Pennsylvania Avenue, NW, Washington, DC, 20037-3213, US

(73) Assignee: SHOWA DENKO K.K.

(21) Appl. No.: 10/260,540

(22) Filed: Oct. 1, 2002

Related U.S. Application Data
(60) Provisional application No. 60/326,735, filed on Oct. 4, 2001.

(30) Foreign Application Priority Data
Oct. 2, 2001 (JP) P2001-305907

(51) Int. Cl. H01G 2/00

(52) U.S. Cl. 361/271

(57) ABSTRACT

A nitrogen-containing niobium particle for capacitors is heated in an inert gas atmosphere, preferably in a vacuum, to obtain a niobium particle where the average nitrogen concentration in the region between a depth of 50 nm and a depth of 200 nm from the surface of the niobium particle is from 0.3 to 4% by mass and preferably, the average nitrogen concentration in the region from the particle surface to a depth of 50 nm is from 0.2 to 1% by mass. This niobium particle is sintered to obtain a sintered body. Using this niobium particle as one part electrode, a dielectric material is provided on the surface of the sintered body and a counter electrode is provided on the dielectric material, whereby a niobium capacitor reduced in the leakage current is obtained.

### CROSS REFERENCE TO RELATED APPLICATIONS

This application is an application filed under 35 U.S.C. §111(a) claiming benefit pursuant to 35 U.S.C. §119(e)(i) of the filing date of the Provisional Application No. 60/326,735 filed Oct. 4, 2001 pursuant to 35 U.S.C. §111(b).

### TECHNICAL FIELD

The present invention relates to a niobium particle, a niobium sintered body, a niobium sintered body (also called an “electrochemically formed body”) having provided on the surface thereof a dielectric material, and a capacitor using the niobium sintered body.

### BACKGROUND ART

For producing a niobium capacitor from a niobium particle, the following method is generally used. First, a molded form of niobium particles, where a niobium lead is inserted, is manufactured and the molded form is then heated to sinter the niobium particles with each other and also sinter the lead wire and the niobium particle in the periphery, whereby an electrically integrated porous niobium sintered body is obtained. Using the lead wire side as an anode, a voltage is applied to perform anodization (also called “electrochemical forming”) of the niobium sintered body, whereby a dielectric film of niobium oxide is formed on the surface (including the inside surface of pore) of the niobium sintered body. Thereafter, a cathode material such as manganese dioxide is filled into voids forming three-dimensional network pores of the niobium sintered body and on the surface thereof, an electrically conducting paste is stacked. This niobium electrochemically formed body is fixed on a lead frame and the resulting device is sealed with resin, whereby a capacitor is obtained.

The niobium capacitor is deficient in that the leakage current passing through the dielectric film upon application of a voltage to the capacitor is high. This is attributable to the property of niobium which readily takes in oxygen in air.

If niobium which had taken in oxygen is sintered, a crystalline niobium oxide as an electric conductor is produced. In general, when niobium is anodized, an amorphous niobium oxide film as a dielectric material is produced on the surface of niobium, however, if niobium containing crystalline niobium oxide is anodized, an amorphous niobium oxide film having mingled therein crystalline niobium oxide is produced. That is, the dielectric film contains in the inside thereof a large number of fine electric conductors. As a result, the capacitor is increased in the leakage current and the reliability thereof decreases.

Heretofore, a method for reducing the leakage current of niobium capacitors has been studied. Among the techniques developed, a method of nitriding a niobium powder or a niobium sintered body is effective. However, this technique does not necessarily reach the level demanded on the market.

### DISCLOSURE OF THE INVENTION

As a result of extensive investigations, the present inventors have found that when the average nitrogen concentration of the layer between a depth of 50 nm and a depth of 200 nm from the surface of a niobium particle is controlled to 0.3 to 4% by mass and furthermore, preferably when the nitrogen concentration of the layer to a depth of 50 nm is controlled to 0.2 to 1% by mass, the leakage current of niobium capacitors can be more reduced than in conventional techniques. The present invention has been accomplished based on this finding.

The reason why the leakage current is more reduced as such than in conventional techniques is considered as follows.

When niobium is anodized, a dielectric film of niobium oxide is formed on the surface of niobium and a structure comprising the inside niobium and the surface niobium oxide layer is constituted. The inside niobium serves as an anode of a capacitor and the niobium oxide layer serves as a dielectric layer of the capacitor.

Nitrogen present in the inside niobium includes two kinds of nitrogen, namely, a nitrogen solid-solubilized between niobium crystal lattices and a nitrogen covalently bonded (hereinafter simply referred to as “bonded”) to niobium. The nitrogen solid-solubilized between niobium crystal lattices prevents the oxygen in the niobium oxide layer from diffusing into the niobium layer, and the nitrogen bonded to niobium prevents oxygen in the niobium oxide layer from bonding to the inside niobium. Accordingly, these two kinds of nitrogen present in the inside niobium both have an effect of reducing the leakage current.

On the other hand, nitrogen present in the niobium oxide layer also includes two kinds of nitrogen, namely, a nitrogen solid-solubilized between niobium oxide crystal lattices and a nitrogen bonded to niobium. The nitrogen solid-solubilized between niobium oxide crystal lattices prevents oxygen in the niobium oxide layer from diffusing into the inside niobium and reduces the leakage current. However, the nitrogen bonded to niobium forms a niobium nitride crystal having electrical conductivity and increases the leakage current. Accordingly, the nitrogen present in the niobium oxide layer differs in the effect on the leakage current depending on its bonded state.

Therefore, when the inside niobium is nitrided to a high concentration and the niobium oxide layer is nitrided to a low concentration, the leakage current of a niobium capacitor can be decreased.

More specifically, the present invention relates to the following inventions:

(1) a niobium particle, which is a nitrogen-containing niobium particle for capacitors, wherein the average nitrogen concentration in the region between a depth of 50 nm and a depth of 200 nm from the particle surface is from 0.3 to 4% by mass;

(2) the niobium particle as described in 1 above, wherein the average nitrogen concentration in the region from the particle surface to a depth of 50 nm is from 0.2 to 1% by mass;

(3) the niobium particle as described in 1 or 2 above, wherein the niobium particle has a particle size of 0.1 to 1,000 μm;

(4) the niobium particle as described in any one of 1 to 3 above, wherein the niobium particle has a specific surface area of 0.5 to 40 m²/g;

(5) a sintered body obtained by sintering the niobium particle described in any one of 1 to 4 above;

(6) a sintered body obtained by anodizing the sintered body described in 5 above to provide a dielectric material on the surface thereof;

(7) a capacitor comprising the sintered body described in 5 above as one part electrode, a dielectric material formed on the surface of the sintered body, and a counter electrode provided on the dielectric material;

(8) the capacitor as described in 7 above, wherein the counter electrode is at least one member selected from an electrolytic solution, an organic semiconductor and an inorganic semiconductor;

(9) the capacitor as described in 8 above, wherein the counter electrode is an organic semiconductor and the organic semiconductor is at least one material selected from the group consisting of an organic semiconductor comprising a benzopyrroline tetramer and chloranile, an organic semiconductor mainly comprising tetrathiotetracene, an organic semiconductor mainly comprising tetracyanoquino-dimethane, and an electrically conducting polymer;

(10) the capacitor as described in 9 above, wherein the electrically conducting polymer is at least one member selected from polypyrrole, polythiophene, polyaniline and substitution derivatives thereof;

(11) the capacitor as described in 9 above, wherein the electrically conducting polymer is an electrically conducting polymer obtained by doping a dopant into a polymer containing a repeating unit represented by the following formula (1) or (2):

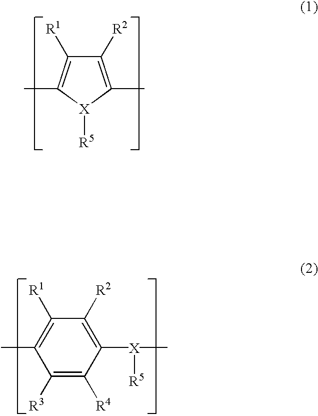

(wherein R¹ to R⁴ each independently represents a monovalent group selected from the group consisting of a hydrogen atom, a linear or branched, saturated or unsaturated alkyl, alkoxy or alkylester group having from 1 to 10 carbon atoms, a halogen atom, a nitro group, a cyano group, a primary, secondary or tertiary amino group, a CF₃ group, a phenyl group and a substituted phenyl group; the hydrocarbon chains of R¹ and R², or R³ and R⁴ may combine with each other at an arbitrary position to form a divalent chain for forming at least one 3-, 4-, 5-, 6- or 7-membered saturated or unsaturated hydrocarbon cyclic structure together with the carbon atoms substituted by R¹ and R² or by R³ and R⁴; the cyclic combined chain may contain a bond of carbonyl, ether, ester, amide, sulfide, sulfinyl, sulfonyl or imino at an arbitrary position; X represents an oxygen atom, a sulfur atom or a nitrogen atom; and R⁵ is present only when X is a nitrogen atom, and independently represents hydrogen or a linear or branched, saturated or unsaturated alkyl group having from 1 to 10 carbon atoms);

(12) the capacitor as described in 11 above, wherein the electrically conducting polymer is an electrically conducting polymer containing a repeating unit represented by the following formula (3):

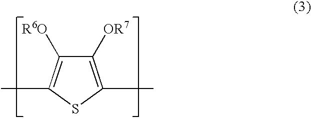

(wherein R⁶ and R⁷ each independently represents a hydrogen atom, a linear or branched, saturated or unsaturated alkyl group having from 1 to 6 carbon atoms, or a substituent for forming at least one 5-, 6- or 7-membered saturated hydrocarbon cyclic structure containing two oxygen elements when the alkyl groups are combined with each other at an arbitrary position; and the cyclic structure includes a structure having a vinylene bond which may be substituted, and a phenylene structure which may be substituted);

(13) the capacitor as described in 12 above, wherein the electrically conducting polymer is an electrically conducting polymer obtained by doping a dopant into poly(3,4-ethylenedioxythiophene);

(14) the capacitor as described in 7 above, wherein the counter electrode is composed of a material having a layer structure at least in a part;

(15) the capacitor as described in 7 above, wherein the counter electrode is a material containing an organic sulfonate anion as a dopant;

(16) a capacitor comprising a niobium sintered body as one part electrode, a dielectric material provided on the surface of the sintered body, and a counter electrode provided on the dielectric material, wherein the niobium sintered body as one part electrode has an average nitrogen concentration of 0.3 to 4% by mass;

(17) the capacitor as described in 16 above, wherein the average nitrogen concentration of the dielectric material is from 0.2 to 1% by mass;

(18) a method for producing the niobium particle described in any one of 1 to 4 above, which is a production method of a nitrogen-containing niobium particle for capacitors, the method comprising a step of heating a nitrogen-containing niobium particle in an inert gas atmosphere;

(19) the method for producing a niobium particle as described in 18 above, wherein the inert gas is argon; and

(20) the method for producing a niobium particle as described in 18 or 19 above, which comprises a step of heating a nitrogen-containing niobium particle in a vacuum.

### DETAILED DESCRIPTION OF THE INVENTION

For the niobium particle as a raw material of niobium capacitors, a primary particle, a secondary particle resulting from agglomeration of primary particles, and/or a particle resulting from agglomeration of secondary particles (hereinafter this particle is referred to as a “tertiary particle”) are used. The average particle size of these particles is usually from 0.1 to 1,000 μm.

For example, for obtaining a primary particle having an average particle size of from 0.1 to 50 μm, a method of pulverizing hydrogenated niobium may be used. The niobium to be hydrogenated is a niobium particle (average particle size: from 0.5 to 100 μm) or a niobium ingot, of which production methods are known. Examples of the pulverizer include a jet mill. The niobium pulverized is then dehydrogenated, whereby a primary particle which can be used in the present invention is obtained.

In the present invention, a secondary particle where several to hundreds of the primary particles are agglomerated can be produced by allowing the above-described primary particle to stand, for example, in an atmosphere at an appropriate temperature, by further cracking the particle after the standing or by still further classifying the particle after the cracking. The secondary particle can be produced to have any average particle size, however, a secondary particle having an average particle size of 0.2 to 1,000 μm is usually used. In the case where the primary particle is obtained by the above-described jet mill method, the secondary particle is preferably produced in the jet mill vessel before taking out the primary particle outside from the jet mill vessel, or in another vessel connected to the jet mill, because excess oxidation can be advantageously prevented.

Also, a method for directly obtaining a secondary particle for capacitors can be proposed, where several to hundreds of niobium primary particles are agglomerated in the secondary particle and the average particle size of the secondary particle is from 0.2 to 1,000 μm. Examples of the method for obtaining this secondary particle include the reduction of niobium halide with an alkali metal, an alkaline earth metal or carbon, the reduction of niobium pentoxide with an alkali metal, an alkaline earth metal, carbon or hydrogen, the reduction of potassium fluoroniobate with an alkali metal, and the molten salt (NaCl+KCl) electrolysis of potassium fluoroniobate on a nickel cathode. Furthermore, a so-called continuous method of halogenating and continuously hydrogen-reducing niobium may also be used.

The specific surface area of the niobium secondary particle obtained by the above-described two methods can be freely changed, however, a niobium secondary particle having a specific surface area of 0.5 to 40 m²/g is usually used.

The tertiary particle is obtained by granulating the secondary particle to an appropriate size. As the granulating method, conventionally known methods can be used. Examples thereof include a method where powder particles are left standing at a high temperature of 500 to 2,000° C. in a vacuum and then wet or dry cracked, a method where powder particles are mixed with an appropriate binder such as acrylic resin or polyvinyl alcohol and then cracked, and a method where powder particles are mixed with an appropriate compound such as acrylic resin, camphor, phosphoric acid or boric acid, left standing at a high temperature in a vacuum and then wet or dry cracked.

The particle size of the tertiary particle can be freely controlled by the degree of granulation and cracking, however, a tertiary particle having an average particle size of 0.4 to 1,000 μm is usually used. The tertiary particle may be classified after the granulation and cracking. After the granulation, an appropriate amount of non-granulated powder particles may be mixed or tertiary particles having a plurality of average particle sizes may be mixed each in an appropriate amount. The specific surface area of the thus-produced tertiary particle can be freely changed, however, a tertiary particle having a specific surface area of 0.3 to 20 m²/g is usually used.

The niobium particle of the present invention usually contains oxygen in an amount of 0.05 to 9% by mass through natural oxidation, though the oxygen amount contained varies depending on the particle size. In order to more reduce the leakage current, the oxygen concentration is preferably 9% by mass or less. In the case where a niobium capacitor is manufactured using a niobium particle having an oxygen concentration in excess of 9% by mass, the capacitor may be not suitable for the practical use due to large leakage current.

In the case where the oxygen concentration of niobium particle exceeds 9% by mass, the oxygen concentration of the niobium particle can be reduced, for example, by mixing the niobium particle with particulate metal which is more readily oxidized than niobium, and heating the mixture in a vacuum. For separating the particulate metal mixed and an oxide thereof from the niobium particle after the oxygen concentration is reduced, a method such as classification using a difference in the particle size or selective etching with an acid or an alkali may be used.

The average nitrogen concentration of the niobium particle of the present invention is non-uniform in the depth direction from the particle surface and must be from 0.3 to 4% by mass in the layer between a depth of 50 nm and a depth of 200 nm from the particle surface. If the average nitrogen concentration is outside this range, the capacitor manufactured from this niobium particle is increased in the leakage current.

Furthermore, the average nitrogen concentration of the niobium particle of the present invention is preferably from 0.2 to 1% by mass in the layer from the particle surface to a depth of 50 nm. By controlling the average nitrogen concentration to fall within this range, the leakage current of a capacitor is more reduced.

In the niobium particle of the present invention, the average nitrogen concentration in the deeper portion than a depth of 200 nm from the particle surface is usually more reduced than that in the shallower portion.

The niobium particle having an average nitrogen concentration in the above-described range can be obtained, for example, by heating a niobium particle at 200 to 1,000° C. in a nitrogen atmosphere. Preferably, the niobium particle heated in a nitrogen atmosphere is further heated at 200 to 1,000° C. in an inert gas atmosphere, for example, in an argon atmosphere. More preferably, the niobium particle heated in a nitrogen atmosphere and then heated in an argon atmosphere is heated at 200 to 1,000° C. in a vacuum. Still more preferably, the niobium particle is prevented from contacting with oxygen during these heating steps and between the steps. In these methods, the average nitrogen concentration and the distribution thereof can be controlled by adjusting the heating temperature, the heating time and the gas pressure.

Other than these, for example, a method of accelerating and implanting nitrogen ion into the inside of the niobium particle by an ion gun can be used. In this method, the average nitrogen concentration can be controlled by adjusting the acceleration voltage and the number of ions.

Examples of the method for measuring the nitrogen concentration in the depth direction include a method where the nitrogen distribution in the depth direction of a niobium foil treated in the same manner as the particle is determined using Auger Electron Spectroscopy (AES) and the obtained distribution is used as the nitrogen distribution of a niobium particle. This is because the nitrogen distribution in the depth direction of a niobium particle is considered the same as the nitrogen distribution in the depth direction of a niobium foil nitrided in the same manner.

The niobium sintered body of the present invention is produced by sintering the above-described niobium particle (preferably, secondary particle or tertiary particle). One example of the production method for the sintered body is described below. The production method for the sintered body is not limited to this example. The sintered body is obtained, for example, by press-molding the niobium particle into a predetermined shape and then heating it at 500 to 2,000° C. for one minute to 10 hours under reduced pressure of 10⁻⁵ to 10² Pa or in an inert gas such as Ar.

Also, a lead wire having appropriate shape and length composed of a valve-acting metal such as niobium or tantalum may be prepared and integrally molded at the press-molding of niobium particle such that a part of the lead wire is inserted inside the molded form, and the lead wire may be designed to serve as an outgoing lead of the sintered body. The specific surface area of the thus-produced niobium sintered body of the present invention can be freely changed but a sintered body having a specific surface area of 1 to 10 m²/g is usually used.

Using this sintered body for one part electrode, a capacitor can be produced by interposing a dielectric material between this one part electrode and the counter electrode.

Preferred examples of the dielectric material for the capacitor include a dielectric material mainly comprising a niobium oxide. For example, the dielectric material mainly comprising a niobium oxide can be obtained by electro chemically forming (anodizing) the niobium sintered body as one part electrode in an electrolytic solution. For electrochemically forming the niobium electrode in an electrolytic solution, an aqueous protonic acid solution is generally used, such as an aqueous 0.1% phosphoric acid solution, an aqueous sulfuric acid solution, an aqueous 1% acetic acid solution or an aqueous adipic acid solution. In the case of obtaining a niobium oxide dielectric material by electrochemically forming a niobium electrode in an electrolytic solution, the capacitor of the present invention is an electrolytic capacitor and the niobium electrode serves as an anode.

In the niobium particle constituting the niobium capacitor of the present invention, the average nitrogen concentration of the portion excluding the dielectric film must be from 0.3 to 4% by mass. If the average nitrogen concentration is out of this range, the leakage current becomes large.

Also, the average nitrogen concentration in the dielectric film of the niobium capacitor of the present invention is preferably from 0.2 to 1% by mass. By controlling the average nitrogen concentration within this range, the leakage current of the niobium capacitor is more reduced.

In the capacitor of the present invention, the counter electrode to the niobium sintered body is not particularly limited and for example, at least one material (compound) selected from electrolytic solutions, organic semi-conductors and inorganic semiconductors known in the art of aluminum electrolytic capacitor, may be used.

Specific examples of the electrolytic solution include a dimethylformamide-ethylene glycol mixed solution having dissolved therein 5 mass % of an isobutyltripropylammonium borotetrafluoride electrolyte, and a propylene carbonate-ethylene glycol mixed solution having dissolved therein 7 mass % of tetraethylammonium borotetrafluoride.

Specific examples of the organic semiconductor include an organic semiconductor comprising benzopyrroline tetramer and chloranile, an organic semiconductor mainly comprising tetrathiotetracene, an organic semiconductor mainly comprising tetracyanoquinodimethane, and an electrically conducting polymer containing a repeating unit represented by the following formula (1) or (2):

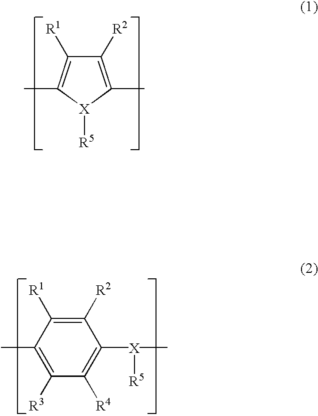

wherein R¹ to R⁴ each independently represents a monovalent group selected from the group consisting of a hydrogen atom, a linear or branched, saturated or unsaturated alkyl, alkoxy or alkylester group having from 1 to 10 carbon atoms, a halogen atom, a nitro group, a cyano group, a primary, secondary or tertiary amino group, a CF₃ group, a phenyl group and a substituted phenyl group; the hydrocarbon chains of R¹ and R², or R³ and R⁴ may combine at an arbitrary position to form a divalent chain for forming at least one 3-, 4-, 5-, 6- or 7-membered saturated or unsaturated hydrocarbon cyclic structure together with the carbon atoms substituted by R¹ and R² or by R³ and R⁴; the cyclic combined chain may contain a bond of carbonyl, ether, ester, amide, sulfide, sulfinyl, sulfonyl or imino at an arbitrary position; X represents an oxygen atom, a sulfur atom or a nitrogen atom; R⁵ is present only when X is a nitrogen atom, and independently represents a hydrogen atom or a linear or branched, saturated or unsaturated alkyl group having from 1 to 10 carbon atoms.

In the present invention, R¹ to R⁴ in formula (1) or (2) each independently preferably represents a hydrogen atom or a linear or branched, saturated or unsaturated alkyl or alkoxy group having from 1 to 6 carbon atoms, and each of the pairs R¹ and R², and R³ and R⁴ may combine to form a ring.

In the present invention, the electrically conducting polymer containing a repeating unit represented by formula (1) is preferably an electrically conducting polymer containing a structure unit represented by the following formula (3) as a repeating unit:

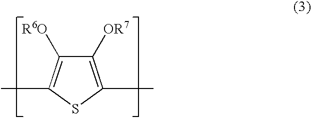

wherein R⁶ and R⁷ each independently represents a hydrogen atom, a linear or branched, saturated or unsaturated alkyl group having from 1 to 6 carbon atoms, or a substituent for forming at least one 5-, 6- or 7-membered saturated hydrocarbon cyclic structure containing two oxygen elements when the alkyl groups are combined with each other at an arbitrary position; and the cyclic structure includes a structure having a vinylene bond which may be substituted, and a phenylene structure which may be substituted.

The electrically conducting polymer containing such a chemical structure bears an electric charge and is doped with a dopant. For the dopant, known dopants can be used without limitation.

Specific examples of the inorganic semiconductor include an inorganic semiconductor mainly comprising lead dioxide or manganese dioxide, and an inorganic semiconductor comprising tri-iron tetroxide. These semiconductors may be used individually or in combination of two or more thereof.

Examples of the polymer containing a repeating unit represented by formula (1) or (2) include polyaniline, polyoxyphenylene, polyphenylene sulfide, polythiophene, polyfuran, polypyrrole, polymethylpyrrole, and substitution derivatives and copolymers thereof. Among these, preferred are polypyrrole, polythiophene and substitution derivatives thereof (e.g., poly(3,4-ethylenedioxythiophene)).

When the organic or inorganic semiconductor used has an electrical conductivity of 10⁻² to 10³ S/cm, the capacitor produced can have a smaller impedance value and can be more increased in the capacitance at a high frequency.

The electrically conducting polymer layer is produced, for example, by a method of polymerizing a polymerizable compound such as aniline, thiophene, furan, pyrrole, methylpyrrole or a substitution derivative thereof under the action of an oxidizing agent capable of satisfactorily undergoing an oxidation reaction of dehydrogenative two-electron oxidation. Examples of the polymerization reaction from the polymerizable compound (monomer) include vapor phase polymerization and solution polymerization of the monomer. The₀ electrically conducting polymer layer is formed on the surface of the niobium sintered body having thereon a dielectric material. In the case where the electrically conducting polymer is an organic solvent-soluble polymer capable of solution coating, a method of coating the polymer on the surface of the sintered body to form an electrically conducting polymer layer is used.

One preferred example of the production method using the solution polymerization is a method of dipping the niobium sintered body having formed thereon a dielectric layer in a solution containing an oxidizing agent (Solution 1) and subsequently dipping the sintered body in a solution containing a monomer and a dopant (Solution 2), thereby performing the polymerization to form an electrically conducting polymer layer on the surface of the sintered body. Also, the sintered body may be dipped in Solution 1 after it is dipped in Solution 2. Solution 2 used in the above-described method may be a monomer solution not containing a dopant. In the case of using a dopant, the dopant may be allowed to be present together in the solution containing an oxidizing agent.

The operation of performing these polymerization steps is repeated once or more, preferably from 3 to 20 times, per the niobium sintered body having thereon a dielectric material, whereby a dense and stratified electrically conducting polymer layer can be easily formed.

In the production method of a capacitor of the present invention, any oxidizing agent may be used insofar as it does not adversely affect the capacitor performance and the reductant of the oxidizing agent can work out to a dopant and elevate the electrical conductivity of the electrically conducting polymer. An industrially inexpensive compound easy to handle at the production is preferred.

Specific examples of the oxidizing agent include Fe(III)-base compounds such as FeCl₃, FeClO₄ and Fe (organic acid anion) salt; anhydrous aluminum chloride/cupurous chloride; alkali metal persulfates; ammonium persulfates; peroxides; manganeses such as potassium permanganate; quinines such as 2,3-dichloro-5,6-dicyano-1,4-benzoquinone (DDQ), tetrachloro-1,4-benzoquinone and tetracyano-1,4-benzoquinone; halogens such as iodine and bromine; peracid; sulfonic acids such as sulfuric acid, fuming sulfuric acid, sulfur trioxide, chlorosulfuric acid, fluorosulfuric acid and amidosulfuric acid; ozone; and a mixture of a plurality of these oxidizing agents.

Examples of the fundamental compound of the organic acid anion for forming the above-described Fe (organic acid anion) salt include organic sulfonic acid, organic carboxylic acid, organic phosphoric acid and organic boric acid. Specific examples of the organic sulfonic acid include benzenesulfonic acid, p-toluenesulfonic acid, methanesulfonic acid, ethanesulfonic acid, α-sulfo-naphthalene, β-sulfonaphthalene, naphthalenedisulfonic acid and alkylnaphthalenesulfonic acid (examples of the alkyl group include butyl, triisopropyl and di-tert-butyl).

Specific examples of the organic carboxylic acid include acetic acid, propionic acid, benzoic acid and oxalic acid. Furthermore, polymer electrolyte anions such as polyacrylic acid, polymethacrylic acid, polystyrene-sulfonic acid, polyvinylsulfonic acid, poly-α-methylsulfonic acid polyvinylsulfate, polyethylenesulfonic acid and polyphosphoric acid may also be used in the present invention. These organic sulfuric acids and organic carboxylic acids are mere examples and the present invention is not limited thereto. Examples of the counter cation to the above-described anion include H⁺, alkali metal ions such as Na⁺ and K⁺, and ammonium ions substituted by a hydrogen atom, a tetramethyl group, a tetraethyl group, a tetrabutyl group or a tetraphenyl group, however, the present invention is not limited thereto. Among these oxidizing agents, preferred are oxidizing agents containing a trivalent Fe-base compound, a cuprous chloride, an alkali persulfate, an ammonium persulfate or a quinone.

For the anion having a dopant ability which is allowed to be present together, if desired, in the production of a polymer composition for the electrically conducting polymer (anion other than the reductant anion of the oxidizing agent), an electrolyte anion having as a counter anion an oxidizing agent anion (a reductant of oxidizing agent) produced from the above-described oxidizing agent, or other electrolyte anion may be used. Specific examples thereof include protonic acid anions including halide anion of Group 5B elements, such as PF₆⁻, SbF₆⁻ and AsF₆⁻; halide anion of Group 3B elements, such as BF₄⁻; halogen anion such as I⁻(I₃⁻), Br⁻ and Cl⁻; perhalogenate anion such as ClO₄⁻; Lewis acid anion such as AlCl₄⁻, FeCl₄⁻, and SnCl₅⁻; inorganic acid anion such as NO₃⁻ and SO₄²⁻; sulfonate anion such as p-toluenesulfonic acid, naphthalenesulfonic acid and alkyl-substituted naphthalenesulfonic acid having from 1 to 5 carbon atoms (hereinafter simply referred to as “C1-5”); organic sulfonate anion such as CF₃SO₃⁻ and CH₃SO₃⁻; and carboxylate anion such as CH₃COO⁻ and C₆H₅COO⁻.

Other examples include polymer electrolyte anions such as polyacrylic acid, polymethacrylic acid, polystyrene-sulfonic acid, polyvinylsulfonic acid, polyvinylsulfuric acid, poly-α-methylsulfonic acid, polyethylenesulfonic acid and polyphosphoric acid. However, the present invention is not limited thereto. Among these anions, preferred are high molecular or low molecular organic sulfonic acid compounds and polyphosphoric acid compounds. Preferably, an aromatic sulfonic acid compound (e.g., sodium dodecylbenzene-sulfonate, sodium naphthalenesulfonate) is used as the anion-donating compound.

Among the organic sulfonate anions, more effective dopants are a sulfoquinone compound having one or more sulfo-anion group (—SO₃⁻) within the molecule and having a quinone structure, and an anthracene sulfonate anion.

Examples of the fundamental skeleton for the sulfoquinone anion of the above-described sulfoquinone compound include p-benzoquinone, o-benzoquinone, 1,2-naphthoquinone, 1,4-naphthoquinone, 2,6-naphthoquinone, 9,10-anthraquinone, 1,4-anthraquinone, 1,2-anthraquinone, 1,4-chrysenquinone, 5,6-chrysenquinone, 6,12-chrysenquinone, acenaphthoquinone, acenaphthenequinone, camphorquinone, 2,3-bornanedione, 9,10-phenanthrenequinone and 2,7-pyrenequinone.

In the case where the counter electrode is solid, an electrically conducting layer may be provided thereon so as to attain good electrical contact with an exterior outgoing lead (for example, lead frame).

The electrically conducting layer can be formed, for example, by the solidification of an electrically conducting paste, the plating, the metallization or the formation of a heat-resistant electrically conducting resin film. Preferred examples of the electrically conducting paste include silver paste, copper paste, aluminum paste, carbon paste and nickel paste, and these may be used individually or in combination of two or more thereof. In the case of using two or more kinds of pastes, the pastes may be mixed or may be superposed one on another as separate layers. The electrically conducting paste applied is then solidified by allowing it to stand in air or under heating. Examples of the plating include nickel plating, copper plating, silver plating and aluminum plating. Examples of the metal vapor-deposited include aluminum, nickel, copper and silver.

More specifically, for example, carbon paste and silver paste are stacked in this order on the counter electrode and these are sealed with a material such as epoxy resin, thereby fabricating a capacitor. This capacitor may have a niobium or tantalum lead which is sintered and molded integrally with the niobium sintered body or welded afterward.

The thus-fabricated capacitor of the present invention is jacketed using, for example, resin mold, resin case, metallic jacket case, dipping of resin or laminate film, and then used as a capacitor product for various uses.

In the case where the counter electrode is liquid, the capacitor fabricated from the above-described two electrodes and dielectric material is housed, for example, in a can electrically connected to the counter electrode to complete the capacitor. In this case, the electrode side of the niobium sintered body is guided outside through a niobium or tantalum lead described above and at the same time, insulated from the can using an insulating rubber or the like.

### BEST MODE FOR CARRYING OUT THE INVENTION

The present invention is described in detail below by referring to Examples and Comparative Examples, however, the present invention is not limited to these Examples.

The nitrogen concentration was measured using an oxygen and nitrogen analyzer manufactured by LECO. The nitrogen distribution of the niobium particle is considered to be the same as that of a niobium foil nitrided in the same manner. Therefore, the same method as in each Example or Comparative Example is applied to a niobium foil separately prepared, the nitrogen distribution of the niobium foil was determined using Auger Electron Spectroscopy (AES), and the obtained distribution was used as the nitrogen distribution of the niobium particle.

### EXAMPLE 1

A secondary particle having an average particle size of 200 μm and a BET specific surface area of 1.2 m²/g was granulated from a niobium primary particle having an average particle size of 1 μm and a BET specific surface area of 2 m²/g. The secondary particle was placed in a high frequency induction heating furnace and nitrided by heating it at a temperature of 400° C. for one hour while passing nitrogen of an atmospheric pressure. Thereafter, the atmosphere within the furnace was displaced by argon and after elevating the temperature in the furnace to 800° C., the nitrided niobium particle was heated for two hours, whereby a part of nitrogen localized on the surface of the niobium particle was diffused inside the niobium particle.

Subsequently, 0.1 g of the secondary particle was weighed and integrally molded with a niobium-made lead wire having a diameter of 0.3 mm and a length of 10 mm. The molded form obtained had a size of 1.7 mm×3.3 mm×4.2 mm and the lead wire of 6 mm was protruded outside vertically from the center of the bottom surface having a size of 1.7 mm×3.3 mm.

This molded form was placed in a high frequency induction heating furnace and after reducing the pressure in the inside to 10⁻² Pa and then elevating the temperature to 1,200° C., sintered for 30 minutes.

The sintered body taken out from the furnace was dipped in an aqueous phosphoric acid solution at a temperature of 80° C. and having a concentration of 0.1% by mass while keeping the lead wire above the liquid surface. Furthermore, a niobium plate separately prepared as a negative electrode was dipped in the phosphoric acid solution and the lead wire was connected to a positive electrode. In the beginning, the sintered body was anodized while keeping the current density at 10 mA. After the voltage applied to the sintered body reached 20 V, the sintered body was anodized for 3 hours while keeping the voltage at 20 V, and thereby an electrochemically formed body was produced.

An aqueous manganese nitrate solution having a concentration of 40% was impregnated into the electro chemically formed body after the anodization and the electrochemically formed body was heated at 105° C. to evaporate the water content and furthermore heated at 200° C. to decompose manganese nitrate into manganese dioxide. The operation from the impregnation of manganese nitrate until the thermal decomposition thereof was repeated a plurality of times and thereby, manganese dioxide as a cathode material was filled inside the electrochemically formed body, thereby forming a counter electrode.

On the electrochemically formed body having filled therein manganese dioxide, a carbon paste and a silver paste were stacked in this order. Thereafter, the electrochemically formed body was mounted on a lead frame and these were sealed with resin.

The leakage current of the niobium capacitor was measured and found to be 2 μA.

A niobium foil nitrided by placing it in the high frequency heating furnace together with the secondary particle was etched from the surface with Ar⁺ ion and the etched surface was analyzed by AES, as a result, the average nitrogen concentration in the region from the surface to a depth of 50 nm was 0.3% by mass and the average nitrogen concentration in the region from a depth of 50 nm to a depth of 200 nm was 0.3% by mass.

Also, a niobium foil nitrided by placing it in the high frequency induction heating furnace together with the secondary particle of Example 1 and then electrochemically formed in the same manner as the sintered body of Example 1 was analyzed by AES, as a result, the average nitrogen concentration of the dielectric film was 0.3% by mass and the average nitrogen concentration in the niobium layer from the boundary with the dielectric film to a depth of 100 nm was 0.3% by mass.

### COMPARATIVE EXAMPLE 1

A secondary particle having an average particle size of 200 μm and a BET specific surface area of 1.2 m²/g was granulated from a niobium primary particle having an average particle size of 1 μm and a BET specific surface area of 2 m²/g. Subsequently, 0.1 g of the secondary particle was weighed and integrally molded with a niobium-made lead wire having a diameter of 0.3 mm and a length of 10 mm. The molded form obtained had a size of 1.7 mm×3.3 mm×4.2 mm, and the lead wire of 6 mm was protruded outside vertically from the center of the bottom surface having a size of 1.7 mm×3.3 mm.

This molded form was placed in a high frequency induction heating furnace and after reducing the pressure in the inside to 10⁻² Pa and then elevating the temperature to 1,200° C., sintered for 30 minutes.

The sintered body taken out from the furnace was dipped in an aqueous phosphoric acid solution at a temperature of 80° C. and having a concentration of 0.1% by mass while keeping the lead wire above the liquid surface. Furthermore, a niobium plate separately prepared as a negative electrode was dipped in the phosphoric acid solution and the lead wire was connected to a positive electrode. In the beginning, the sintered body was anodized while keeping the current density at 10 mA. After the voltage applied to the sintered body reached 20 V, the sintered body was anodized for 3 hours while keeping the voltage at 20 V, and thereby an electrochemically formed body was produced.

An aqueous manganese nitrate solution having a concentration of 40% was impregnated into the electro chemically formed body after the anodization and the electrochemically formed body was heated at 105° C. to evaporate the water content and furthermore heated at 200° C. to decompose manganese nitrate into manganese dioxide. The operation from the impregnation of manganese nitrate until the thermal decomposition thereof was repeated a plurality of times and thereby, manganese dioxide as a cathode material was filled inside the electrochemically formed body, thereby forming a counter electrode.

On the electrochemically formed body having filled therein manganese dioxide, a carbon paste and a silver paste were stacked in this order. Thereafter, the electrochemically formed body was mounted on a lead frame and these were sealed with resin.

A voltage of 6.3 V was applied to the niobium capacitor produced and after one minute, the current (leakage current) passing through the capacitor was measured and found to be 62.3 μA.

The niobium sintered body after the anodization was cut and the cut surface was observed through a scanning electron microscope (SEM), as a result, the thickness of the dielectric film was 100 nm.

A niobium foil was etched from the surface with Ar⁺ ion and the etched surface was analyzed by AES, as a result, the average nitrogen concentration in the region from the surface to a depth of 50 nm was 0.0% by mass and the average nitrogen concentration in the region from a depth of 50 nm to a depth of 200 nm was 0.0% by mass.

Also, a niobium foil electrochemically formed in the same manner as the above-described sintered body was analyzed by AES, as a result, the average nitrogen concentration of the dielectric film was 0.0% by mass and the average nitrogen concentration in the niobium layer from the boundary with the dielectric film to a depth of 100 nm was 0.0% by mass.

### COMPARATIVE EXAMPLE 2

A secondary particle having an average particle size of 200 μm and a BET specific surface area of 1.2 m²/g was granulated from a niobium primary particle having an average particle size of 1 μm and a BET specific surface area of 2 m²/g. The secondary particle was placed in a high frequency induction heating furnace and nitrided by heating it at a temperature of 400° C. for one hour while passing nitrogen of an atmospheric pressure.

The niobium particle taken out from the furnace was processed in the same manner as in Comparative Example 1 to produce a niobium capacitor.

The leakage current of the niobium capacitor was measured and found to be 43.4 μA.

A niobium foil nitrided by placing it in the high frequency heating furnace together with the secondary particle was analyzed by AES, as a result, the average nitrogen concentration in the region from the surface to a depth of 50 nm was 0.7% by mass and the average nitrogen concentration in the region from a depth of 50 nm to a depth of 200 nm was 0.3% by mass.

Also, a niobium foil nitrided by placing it in the high frequency induction heating furnace together with the secondary particle of Comparative Example 2 was electrochemically formed in the same manner as in Comparative Example 1 and then analyzed by AES. As a result, the average nitrogen concentration of the dielectric film was 0.7% by mass and the average nitrogen concentration of the niobium layer from the boundary with the dielectric film to a depth of 100 nm was 0.3% by mass.

### COMPARATIVE EXAMPLE 3

A secondary particle having an average particle size of 200 μm and a BET specific surface area of 1.2 m²/g was granulated from a niobium primary particle having an average particle size of 1 μm and a BET specific-surface area of 2 m²/g. The secondary particle was placed in a high frequency induction heating furnace and nitrided by heating it at a temperature of 400° C. for one hour while passing nitrogen of an atmospheric pressure. Thereafter, the atmosphere within the furnace was displaced by argon and after elevating the temperature in the furnace to 800° C., the nitrided secondary particle was heated for two hours, whereby a part of nitrogen localized on the surface of the niobium particle was diffused inside the niobium particle. Furthermore, the inside of the furnace was vacuumized and kept at a temperature of 800° C. for 10 minutes, thereby diffusing nitrogen present in the vicinity of the niobium particle surface to the outside of the particle.

The niobium particle taken out from the furnace was processed in the same manner as in Comparative Example 1 to produce a niobium capacitor.

The leakage current of the niobium capacitor was measured and found to be 9.2 μA.

A niobium foil nitrided by placing it in the high frequency heating furnace together with the secondary particle was analyzed by AES, as a result, the average nitrogen concentration in the region from the surface to a depth of 50 nm was 0.1% by mass and the average nitrogen concentration in the region from a depth of 50 nm to a depth of 200 nm was 0.3% by mass.

Also, a niobium foil nitrided by placing it in the high frequency induction heating furnace together with the secondary particle of Comparative Example 3 was electrochemically formed in the same manner as in Comparative Example 1 and then analyzed by AES. As a result, the average nitrogen concentration of the dielectric film was 0.1% by mass and the average nitrogen concentration in the niobium layer from the boundary with the dielectric film to a depth of 100 nm was 0.3% by mass.

### COMPARATIVE EXAMPLE 4

A secondary particle having an average particle size of 200 μm and a BET specific surface area of 1.2 m²/g was granulated from a niobium primary particle having an average particle size of 1 μm and a BET specific surface area of 2 m²/g. The secondary particle was placed in a high frequency induction heating furnace and nitrided by heating it at a temperature of 500° C. for one hour while passing nitrogen of an atmospheric pressure.

The niobium particle taken out from the furnace was processed in the same manner as in Comparative Example 1 to produce a niobium capacitor.

The leakage current of the niobium capacitor was measured and found to be 10.5 μA.

A niobium foil nitrided by placing it in the high frequency heating furnace together with the secondary particle was analyzed by AES, as a result, the average nitrogen concentration in the region from the surface to a depth of 50 nm was 1.7% by mass and the average nitrogen concentration in the region from a depth of 50 nm to a depth of 200 nm was 0.9% by mass.

Also, a niobium foil nitrided by placing it in the high frequency induction heating furnace together with the secondary particle of Comparative Example 4 was electrochemically formed in the same manner as in Comparative Example 1 and then analyzed by AES. As a result, the average nitrogen concentration of the dielectric film was 1.7% by mass and the average nitrogen concentration of the niobium layer from the boundary with the dielectric film to a depth of 100 nm was 0.9% by mass.

### EXAMPLE 2

A secondary particle having an average particle size of 200 μm and a BET specific surface area of 1.2 m²/g was granulated from a niobium primary particle having an average particle size of 1 μm and a BET specific surface area of 2 m²/g. The secondary particle was placed in a high frequency induction heating furnace and nitrided by heating it at a temperature of 500° C. for one hour while passing nitrogen of an atmospheric pressure. Thereafter, the atmosphere within the furnace was displaced by argon and after elevating the temperature in the furnace to 800° C., the nitrided secondary particle was heated for two hours, whereby a part of nitrogen localized on the surface of the niobium particle was diffused inside the niobium particle.

The niobium particle taken out from the furnace was processed in the same manner as in Comparative Example 1 to produce a niobium capacitor.

The leakage current of the niobium capacitor was measured and found to be 5.8 μA.

A niobium foil nitrided by placing it in the high frequency heating furnace together with the secondary particle was analyzed by AES, as a result, the average nitrogen concentration in region from the surface to a depth of 50 nm was 0.9% by mass and the average nitrogen concentration in the region from a depth of 50 nm to a depth of 200 nm was 0.9% by mass.

Also, a niobium foil nitrided by placing it in the high frequency induction heating furnace together with the secondary particle of Example 2 was electrochemically formed in the same manner as in Comparative Example 1 and then analyzed by AES. As a result, the average nitrogen concentration of the dielectric film was 0.9% by mass and the average nitrogen concentration of the niobium layer from the boundary with the dielectric film to a depth of 100 nm was 0.9% by mass.

### EXAMPLE 3

A secondary particle having an average particle size of 200 μm and a BET specific surface area of 1.2 m²/g was granulated from a niobium primary particle having an average particle size of 1 μm and a BET specific surface area of 2 m²/g. The secondary particle was placed in a high frequency induction heating furnace and nitrided by heating it at a temperature of 500° C. for one hour while passing nitrogen of an atmospheric pressure. Thereafter, the atmosphere within the furnace was displaced by argon and after elevating the temperature in the furnace to 800° C., the nitrided secondary particle was heated for two hours, whereby a part of nitrogen localized on the surface of the niobium particle was diffused inside the niobium particle. Furthermore, the inside of the furnace was vacuumized and kept at a temperature of 800° C. for 10 minutes, thereby diffusing nitrogen present in the vicinity of the niobium particle surface to the outside of the particle.

The niobium particle taken out from the furnace was processed in the same manner as in Comparative Example 1 to produce a niobium capacitor.

The leakage current of the niobium capacitor was measured and found to be 3.5 μA.

The thickness of the dielectric film was measured and found to be 100 nm.

A niobium foil nitrided by placing it in the high frequency heating furnace together with the secondary particle was analyzed by AES, as a result, the average nitrogen concentration in the region from the surface to a depth of 50 nm was 0.1% by mass and the average nitrogen concentration in the region from a depth of 50 nm to a depth of 200 nm was 0.3% by mass.

Also, a niobium foil nitrided by placing it in the high frequency induction heating furnace together with the secondary particle of Example 3 was electrochemically formed in the same manner as in Comparative Example 1 and then analyzed by AES. As a result, the average nitrogen concentration of the dielectric film was 0.1% by mass and the average nitrogen concentration of the niobium layer from the boundary with the dielectric film to a depth of 100 nm was 0.3% by mass.

### COMPARATIVE EXAMPLE 5

A secondary particle having an average particle size of 200 μm and a BET specific surface area of 1.2 m²/g was granulated from a niobium primary particle having an average particle size of 1 μm and a BET specific surface area of 2 m²/g. The secondary particle was placed in a high frequency induction heating furnace and nitrided by heating it at a temperature of 600° C. for one hour while passing nitrogen of an atmospheric pressure.

The niobium particle taken out from the furnace was processed in the same manner as in Comparative Example 1 to produce a niobium capacitor.

The leakage current of the niobium capacitor was measured and found to be 10.9 μA.

A niobium foil nitrided by placing it in the high frequency heating furnace together with the secondary particle was analyzed by AES, as a result, the average nitrogen concentration in the region from the surface to a depth of 50 nm was 5.3% by mass and the average nitrogen concentration in the region from a depth of 50 nm to a depth of 200 nm was 3.2% by mass.

Also, a niobium foil nitrided by placing it in the high frequency induction heating furnace together with the secondary particle of Comparative Example 5 was electro chemically formed in the same manner as in Comparative Example 1 and then analyzed by AES. As a result, the average nitrogen concentration of the dielectric film was 5.3% by mass and the average nitrogen concentration of the niobium layer from the boundary with the dielectric film to a depth of 100 nm was 3.2% by mass.

### COMPARATIVE EXAMPLE 6

A secondary particle having an average particle size of 200 μm and a BET specific surface area of 1.2 m²/g was granulated from a niobium primary particle having an average particle size of 1 μm and a BET specific surface area of 2 m²/g. The secondary particle was placed in a high frequency induction heating furnace and nitrided by heating it at a temperature of 600° C. for one hour while passing nitrogen of an atmospheric pressure. Thereafter, the atmosphere within the furnace was displaced by argon and after elevating the temperature in the furnace to 800° C., the nitrided secondary particle was heated for two hours, whereby a part of nitrogen localized on the surface of the niobium particle were diffused inside the niobium particle.

The niobium particle taken out from the furnace was processed in the same manner as in Comparative Example 1 to produce a niobium capacitor.

The leakage current of the niobium capacitor was measured and found to be 8.8 μA.

A niobium foil nitrided by placing it in the high frequency heating furnace together with the secondary particle was analyzed by AES, as a result, the average nitrogen concentration in the region from the surface to a depth of 50 nm was 3.4% by mass and the average nitrogen concentration in the region from a depth of 50 nm to a depth of 200 nm was 3.4% by mass.

Also, a niobium foil nitrided by placing it in the high frequency induction heating furnace together with the secondary particle of Comparative Example 6 was electro chemically formed in the same manner as in Comparative Example 1 and then analyzed by AES. As a result, the average nitrogen concentration of the dielectric film was 3.4% by mass and the average nitrogen concentration of the niobium layer from the boundary with the dielectric film to a depth of 100 nm was 3.4% by mass.

### EXAMPLE 4

A secondary particle having an average particle size of 200 μm and a BET specific surface area of 1.2 m²/g was granulated from a niobium primary particle having an average particle size of 1 μm and a BET specific surface area of 2 m²/g. The secondary particle was placed in a high frequency induction heating furnace and nitrided by heating it at a temperature of 600° C. for one hour while passing nitrogen of an atmospheric pressure. Thereafter, the atmosphere within the furnace was displaced by argon and after elevating the temperature in the furnace to 800° C., the nitrided secondary particle was heated for two hours, whereby a part of nitrogen localized on the surface of the niobium particle was diffused inside the niobium particle. Furthermore, the inside of the furnace was vacuumized and kept at a temperature of 800° C. for 10 minutes, thereby diffusing nitrogen present in the vicinity of the niobium particle surface to the outside of the particle.

The niobium particle taken out from the furnace was processed in the same manner as in Comparative Example 1 to produce a niobium capacitor.

The leakage current of the niobium capacitor was measured and found to be 2.1 μA.

A niobium foil nitrided by placing it in the high frequency heating furnace together with the secondary particle was analyzed by AES, as a result, the average nitrogen concentration in the region from the surface to a depth of 50 nm was 0.5% by mass and the average nitrogen concentration in the region from a depth of 50 nm to a depth of 200 nm was 3.4% by mass.

Also, a niobium foil nitrided by placing it in the high frequency induction heating furnace together with the secondary particle of Example 4 was electrochemically formed in the same manner as in Comparative Example 1 and then analyzed by AES. As a result, the average nitrogen concentration of the dielectric film was 0.5% by mass and the average nitrogen concentration of the niobium layer from the boundary with the dielectric film to a depth of 100 nm was 3.4% by mass.

### COMPARATIVE EXAMPLE 7

A secondary particle having an average particle size of 200 μm and a BET specific surface area of 1.2 m²/g was granulated from a niobium primary particle having an average particle size of 1 μm and a BET specific surface area of 2 m²/g. The secondary particle was placed in a high frequency induction heating furnace and nitrided by heating it at a temperature of 700° C. for one hour while passing nitrogen of an atmospheric pressure.

The niobium particle taken out from the furnace was processed in the same manner as in Comparative Example 1 to produce a niobium capacitor.

The leakage current of the niobium capacitor was measured and found to be 163.5 μA.

A niobium foil nitrided by placing it in the high frequency heating furnace together with the secondary particle was analyzed by AES, as a result, the average nitrogen concentration in the region from the surface to a depth of 50 nm was 7% by mass and the average nitrogen concentration in the region from a depth of 50 nm to a depth of 200 nm was 5.1% by mass.

Also, a niobium foil nitrided by placing it in the high frequency induction heating furnace together with the secondary particle of Comparative Example 7 was electro chemically formed in the same manner as in Comparative Example 1 and then analyzed by AES. As a result, the average nitrogen concentration of the dielectric film was 0.7% by mass and the average nitrogen concentration of the niobium layer from the boundary with the dielectric film to a depth of 100 nm was 5.1% by mass.

### COMPARATIVE EXAMPLE 8

A secondary particle having an average particle size of 200 μm and a BET specific surface area of 1.2 m²/g was granulated from a niobium primary particle having an average particle size of 1 μm and a BET specific surface area of 2 m²/g. The secondary particle was placed in a high frequency induction heating furnace and nitrided by heating it at a temperature of 700° C. for one hour while passing nitrogen of an atmospheric pressure. Thereafter, the atmosphere within the furnace was displaced by argon and after elevating the temperature in the furnace to 800° C., the nitrided secondary particle was heated for two hours, whereby a part of nitrogen localized on the surface of the niobium particle was diffused inside the niobium particle.

The niobium particle taken out from the furnace was processed in the same manner as in Comparative Example 1 to produce a niobium capacitor.

The leakage current of the niobium capacitor was measured and found to be 84.6 μA.

A niobium foil nitrided by placing it in the high frequency heating furnace together with the secondary particle was analyzed by AES, as a result, the average nitrogen concentration in the region from the surface to a depth of 50 nm was 5.3% and the average nitrogen concentration in the region from a depth of 50 nm to a depth of 200 nm was 5.3% by mass.

Also, a niobium foil nitrided by placing it in the high frequency induction heating furnace together with the secondary particle of Comparative Example 8 was electro chemically formed in the same manner as in Comparative Example 1 and then analyzed by AES. As a result, the average nitrogen concentration of the dielectric film was 5.3% by mass and the average nitrogen concentration of the niobium layer from the boundary with the dielectric film to a depth of 100 nm was 5.3% by mass.

### COMPARATIVE EXAMPLE 9

A secondary particle having an average particle size of 200 μm and a BET specific surface area of 1.2 m²/g was granulated from a niobium primary particle having an average particle size of 1 μm and a BET specific surface area of 2 m²/g. The secondary particle was placed in a high frequency induction heating furnace and nitrided by heating it at a temperature of 700° C. for one hour while passing nitrogen of an atmospheric pressure. Thereafter, the atmosphere within the furnace was displaced by argon and after elevating the temperature in the furnace to 800° C., the nitrided secondary particle was heated for two hours, whereby a part of nitrogen localized on the surface of the niobium particle was diffused inside the niobium particle. Furthermore, the inside of the furnace was vacuumized and kept at a temperature of 800° C. for 10 minutes, thereby diffusing nitrogen present in the vicinity of the niobium particle surface to the outside of the particle.

The niobium particle taken out from the furnace was processed in the same manner as in Comparative Example 1 to produce a niobium capacitor.

The leakage current of the niobium capacitor was measured and found to be 23.6 μA.

A niobium foil nitrided by placing it in the high frequency heating furnace together with the secondary particle was analyzed by AES, as a result, the average nitrogen concentration in the region from the surface to a depth of 50 nm was 0.5% by mass and the average nitrogen concentration in the region from a depth of 50 nm to a depth of 200 nm was 5.2% by mass.

Also, a niobium foil nitrided by placing it in the high frequency induction heating furnace together with the secondary particle of Comparative Example 9 was electro chemically formed in the same manner as in Comparative Example 1 and then analyzed by AES. As a result, the average nitrogen concentration of the dielectric film was 0.5% by mass and the average nitrogen concentration of the niobium layer from the boundary with the dielectric film to a depth of 100 nm was 5.2% by mass.

### EXAMPLE 5

A secondary particle having an average particle size of 200 μm and a BET specific surface area of 0.7 m²/g was granulated from a niobium primary particle having an average particle size of 2 μm and a BET specific surface area of 1 m²/g. The secondary particle was placed in a high frequency induction heating furnace and nitrided by heating it at a temperature of 400° C. for one hour while passing nitrogen of an atmospheric pressure.

The niobium particle taken out from the furnace was processed in the same manner as in Comparative Example 1 to produce a niobium capacitor.

The leakage current of the niobium capacitor was measured and found to be 1.1 μA.

A niobium foil nitrided by placing it in the high frequency heating furnace together with the secondary particle was analyzed by AES, as a result, the average nitrogen concentration in the region from the surface to a depth of 50 nm was 0.7% by mass and the average nitrogen concentration in the region from a depth of 50 nm to a depth of 200 nm was 0.3% by mass.

Also, a niobium foil nitrided by placing it in the high frequency induction heating furnace together with the secondary particle of Example 5 was electrochemically formed in the same manner as in Comparative Example 1 and then analyzed by AES. As a result, the average nitrogen concentration of the dielectric film was 0.7% by mass and the average nitrogen concentration of the niobium layer from the boundary with the dielectric film to a depth of 100 nm was 0.3% by mass.

### EXAMPLE 6

A secondary particle having an average particle size of 200 μm and a BET specific surface area of 3 m²/g was granulated from a niobium primary particle having an average particle size of 0.5 μm and a BET specific surface area of 5 m²/g. The secondary particle was placed in a high frequency induction heating furnace and nitrided by heating it at a temperature of 400° C. for one hour while passing nitrogen of an atmospheric pressure.

The niobium particle taken out from the furnace was processed in the same manner as in Comparative Example 1 to produce a niobium capacitor.

The leakage current of the niobium capacitor was measured and found to be 5.9 μA.

A niobium foil nitrided by placing it in the high frequency heating furnace together with the secondary particle was analyzed by AES, as a result, the average nitrogen concentration in the region from the surface to a depth of 50 nm was 0.7% by mass and the average nitrogen concentration in the region from a depth of 50 nm to a depth of 200 nm was 0.3% by mass.

Also, a niobium foil nitrided by placing it in the high frequency induction heating furnace together with the secondary particle of Example 6 was electrochemically formed in the same manner as in Comparative Example 1 and then analyzed by AES. As a result, the average nitrogen concentration of the dielectric film was 0.7% by mass and the average nitrogen concentration of the niobium layer from the boundary with the dielectric film to a depth of 100 nm was 0.3% by mass.

The average nitrogen concentration in the region from the surface to a depth of 50 nm, the average nitrogen concentration in the region from a depth of 50 nm to a depth of 200 nm and the leakage current of the niobium capacitors of each niobium particle produced in Examples 1 to 6 and Comparative Examples 1 to 9 are shown together in Table 1.

TABLE 1

| | |
|---|---|
| Treatment of Niobium Powder | Average Nitrogen |
| (temperature, time) | Concentration (mass%) |

| Example and | Average Particle | Under | | | From | From Depth of | Leakage |
|---|---|---|---|---|---|---|---|
| Comparative | Size of Primary | Nitrogen | Under Argon | | Surface | 50 nm to Depth | Current |
| Example | Particle (μm) | of 1 atm | of 1 atm | In Vacuum | to 50 nm | of 200 nm | (μA) |
| Example 1 | 1 | 400° C., 1 hour | 800° C., 2 hours | none | 0.3 | 0.3 | 2.0 |
| Comparative | 1 | none | none | none | 0.0 | 0.0 | 62.3 |
| Example 1 | | | | | | | |
| Comparative | 1 | 400° C., 1 hour | none | none | 0.7 | 0.2 | 43.4 |
| Example 2 | | | | | | | |
| Comparative | 1 | 400° C., 1 hour | 800° C., 2 hours | 800° C., 10 min | 0.1 | 0.3 | 9.2 |
| Example 3 | | | | | | | |
| Comparative | 1 | 500° C., 1 hour | none | none | 1.7 | 0.9 | 10.5 |
| Example 4 | | | | | | | |
| Example 2 | 1 | 500° C., 1 hour | 800° C., 2 hours | none | 0.9 | 0.9 | 5.8 |
| Example 3 | 1 | 500° C., 1 hour | 800° C., 2 hours | 800° C., 10 min | 0.2 | 0.9 | 3.5 |
| Comparative | 1 | 600° C., 1 hour | none | none | 5.3 | 3.2 | 10.9 |
| Example 5 | | | | | | | |
| Comparative | 1 | 600° C., 1 hour | 800° C., 2 hours | none | 3.4 | 3.4 | 8.8 |
| Example 6 | | | | | | | |
| Example 4 | 1 | 600° C., 1 hour | 800° C., 2 hours | 800° C., 10 min | 0.5 | 3.4 | 2.1 |
| Comparative | 1 | 700° C., 1 hour | none | none | 0.7 | 5.1 | 163.5 |
| Example 7 | | | | | | | |
| Comparative | 1 | 700° C., 1 hour | 800° C., 2 hours | none | 5.3 | 5.3 | 84.6 |
| Example 8 | | | | | | | |
| Comparative | 1 | 700° C., 1 hour | 800° C., 2 hours | 800° C., 10 min | 0.5 | 5.2 | 23.6 |
| Example 9 | | | | | | | |
| Example 5 | 2 | 400° C., 1 hour | none | none | 0.7 | 0.3 | 1.1 |
| Example 6 | 0.8 | 400° C., 1 hour | none | none | 0.6 | 0.3 | 5.9 |

As is apparent from Table 1, when the average nitrogen concentration in the region from a depth of 50 nm to a depth of 200 nm of a niobium particle is from 0.3 to 4% by mass, the leakage current of the niobium capacitor is 10.9 μA or less. Furthermore, when the average nitrogen concentration in the region from a depth of 50 nm to a depth of 200 nm of a niobium particle is from 0.3 to 4% by mass and the average nitrogen concentration in the region from the surface to a depth of 50 nm is from 0.2 to 1% by mass, the leakage current of the niobium capacitor is 5.9 μA or less. On the other hand, when the average niobium concentration in the region from a depth of 50 nm to a depth of 200 nm of a niobium particle is less than 0.3% by mass or exceeds 4% by mass, the leakage current of niobium capacitors is 23.6 μA or more.

From these, it is understood that when the niobium particle is nitrided and the nitrogen concentration of the layer from a depth of 50 nm to a depth of 200 nm is controlled to 0.3 to 4% by mass, the leakage current of niobium capacitors decreases. Also, it is understood that when the average nitrogen concentration of the layer from a depth of 50 nm to a depth of 200 nm is controlled to from 0.3 to 4% by mass and the average nitrogen concentration of the layer from the surface to a depth of 50 nm is controlled to from 0.2 to 1% by mass, the leakage current of niobium capacitors more decreases.

### INDUSTRIAL APPLICABILITY

A niobium capacitor reduced in the leakage current can be produced by using the niobium particle of the present invention where the nitrogen concentration of the layer from the particle surface to a depth of 50 nm is controlled to 0.2 to 1% by mass and furthermore, the average nitrogen concentration of the layer from a depth of 50 nm to a depth of 200 nm is preferably controlled to 0.3 to 4% by mass.

What is claimed is:

1. A niobium particle, which is a nitrogen-containing niobium particle for capacitors, wherein the average nitrogen concentration in the region between a depth of 50 nm and a depth of 200 nm from the particle surface is from 0.3 to 4% by mass.

2. The niobium particle as claimed in claim 1, wherein the average nitrogen concentration in the region from the particle surface to a depth of 50 nm is from 0.2 to 1% by mass.

3. The niobium particle as claimed in claim 1 or 2, wherein the niobium particle has a particle size of 0.1 to 1,000 μm.

4. The niobium particle as claimed in any one of claims 1 to 3, wherein the niobium particle has a specific surface area of 0.5 to 40 m²/g.

5. A sintered body obtained by sintering the niobium particle claimed in any one of claims 1 to 4.

6. A sintered body obtained by anodizing the sintered body claimed in claim 5 to provide a dielectric material on the surface thereof.

7. A capacitor comprising the sintered body claimed in claim 5 as one part electrode, a dielectric material formed on the surface of the sintered body, and a counter electrode provided on said dielectric material.

8. The capacitor as claimed in claim 7, wherein the counter electrode is at least one member selected from an electrolytic solution, an organic semiconductor and an inorganic semiconductor.

9. The capacitor as claimed in claim 8, wherein the counter electrode is an organic semiconductor and the organic semiconductor is at least one material selected from the group consisting of an organic semiconductor comprising a benzopyrroline tetramer and chloranile, an organic semiconductor mainly comprising tetrathiotetracene, an organic semiconductor mainly comprising tetracyanoquino-dimethane, and an electrically conducting polymer.

10. The capacitor as claimed in claim 9, wherein the electrically conducting polymer is at least one member selected from polypyrrole, polythiophene, polyaniline and substitution derivatives thereof.

11. The capacitor as claimed in claim 9, wherein the electrically conducting polymer is an electrically conducting polymer obtained by doping a dopant into a polymer containing a repeating unit represented by the following formula (1) or (2): 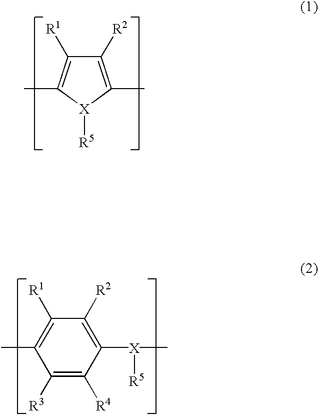
(wherein R¹ to R⁴ each independently represents a monovalent group selected from the group consisting of a hydrogen atom, a linear or branched, saturated or unsaturated alkyl, alkoxy or alkylester group having from 1 to 10 carbon atoms, a halogen atom, a nitro group, a cyano group, a primary, secondary or tertiary amino group, a CF₃ group, a phenyl group and a substituted phenyl group; the hydrocarbon chains of R¹ and R², or R³ and R⁴ may combine with each other at an arbitrary position to form a divalent chain for forming at least one 3-, 4-, 5-, 6- or 7-membered saturated or unsaturated hydrocarbon cyclic structure together with the carbon atoms substituted by R¹ and R² or by R³ and R⁴; the cyclic combined chain may contain a bond of carbonyl, ether, ester, amide, sulfide, sulfinyl, sulfonyl or imino at an arbitrary position; X represents an oxygen atom, a sulfur atom or a nitrogen atom; and R⁵ is present only when X is a nitrogen atom, and independently represents hydrogen or a linear or branched, saturated or unsaturated alkyl group having from 1 to 10 carbon atoms).

12. The capacitor as claimed in claim 11, wherein the electrically conducting polymer is an electrically conducting polymer containing a repeating unit represented by the following formula (3): 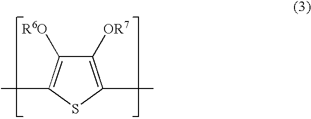
(wherein R⁶ and R⁷ each independently represents a hydrogen atom, a linear or branched, saturated or unsaturated alkyl group having from 1 to 6 carbon atoms, or a substituent for forming at least one 5-, 6- or 7-membered saturated hydrocarbon cyclic structure containing two oxygen elements when the alkyl groups are combined with each other at an arbitrary position; and the cyclic structure includes a structure having a vinylene bond which may be substituted, and a phenylene structure which may be substituted).

13. The capacitor as claimed in claim 12, wherein the electrically conducting polymer is an electrically conducting polymer obtained by doping a dopant into poly(3,4-ethylenedioxythiophene).

14. The capacitor as claimed in claim 7, wherein the counter electrode is composed of a material having a layer structure at least in a part.

15. The capacitor as claimed in claim 7, wherein the counter electrode is a material containing an organic sulfonate anion as a dopant.

16. A capacitor comprising a niobium sintered body as one part electrode, a dielectric material provided on the surface of the sintered body, and a counter electrode provided on said dielectric material, wherein the niobium sintered body as one part electrode has an average nitrogen concentration of 0.3 to 4% by mass.

17. The capacitor as claimed in claim 16, wherein the average nitrogen concentration of the dielectric material is from 0.2 to 1% by mass.

18. A method for producing the niobium particle claimed in any one of claims 1 to 4, which is a production method of a nitrogen-containing niobium particle for capacitors, the method comprising a step of heating a nitrogen-containing niobium particle in an inert gas atmosphere.

19. The method for producing a niobium particle as claimed in claim 18, wherein the inert gas is argon.

20. The method for producing a niobium particle as claimed in claim 18, which comprises a step of heating a nitrogen-containing niobium particle in a vacuum.
